(19) United States
(12) Patent Application Publication
(10) Pub. No.: US 2006/0248393 A1
(43) Pub. Date: Nov. 2, 2006

(54) Electronic apparatus

(75) Inventor: Tetsuo Hatakeyama, Tachikawa-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/393,229

(22) Filed: Mar. 30, 2006

(30) Foreign Application Priority Data
Apr. 28, 2005 (JP) 2005-132076

(51) Int. Cl. G06F 11/00

(52) U.S. Cl. 714/30

(57) ABSTRACT

According to one embodiment, an electronic apparatus including a processor including an input terminal to which a debug signal is to be input, a first switch configured to switch between permission and inhibition of passage of the debug signal, a first control unit configured to output a control signal for causing the first switch to perform the switching between the permission and inhibition of passage of the debug signal based on an externally supplied command signal, a second switch configured to convert a control signal outputted from the first control unit for permitting the passage of the debug signal into a control signal for inhibiting the debug signal, and a second control unit configured to output a control signal for causing the second switch to determine whether or not to perform the conversion based on a command signal from the processor.

### CROSS-REFERENCE TO RELATED APPLICATIONS

This application is based upon and claims the benefit of priority from Japanese Patent Application No. 2005-132076, filed Apr. 28, 2005, the entire contents of which are incorporated herein by reference.

### BACKGROUND

1. Field

One embodiment of the invention relates to a security control technique for appropriately performing a control on switching between permission and inhibition of passage of a debug signal in order to prevent an illegal access using a debug device to an integrated circuit.

2. Description of the Related Art

In recent years, techniques for manufacturing semiconductor devices have been remarkably improved, and various kinds of high-performance integrated circuits incorporating processors have been developed. In general, in order that such kinds of integrated circuits be efficiently developed and evaluated, a processor to be incorporated into each integrated circuit is formed to be capable of operating in response to a debug signal from a debug device located at the outside of the processor (it should be noted that this operation includes outputting of trace information). Various methods of efficiently developing or evaluating such integrated circuits have been proposed (as disclosed in, e.g., Jpn. Pat. Appln. KOKAI Publications No. 11-282713 and No. 11-282715).

It should be noted that a control using the debug device enables integrated circuits to be efficiently developed and evaluated; however, it causes the following problem in security: there is a risk that the debug device may be illegally used to read the processing procedure of the processor in an integrated circuit to be subjected to the control using the debug device.

In view of such a problem, according to a method, the integrated circuit (processor) is formed to have a function of effecting switching between permission and inhibition of passage of the debug signal from the debug device. However, in this method also, in the case where the switching between permission and inhibition of passage of the debug signal is carried out based on a control signal supplied from an external device, the above problem is not solved (since there is a possibility that the way of using the control signal may be leaked). On the other hand, in the case where the switching is controlled in the processor, if the passage of the debug signal from the debug device is inhibited against the intention of an operator due to, e.g., an error in a program for operating the processor, the above inhibition of the passage of the debug signal cannot be stopped.

In view of such circumstances, when an integrated circuit is developed, it is strongly required to have a function of appropriately effecting switching permission and inhibition of the passage of a debug signal from the debug signal in accordance with the situation, e.g., in accordance with what processing is carried out in development of the integrated circuit.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the configuration of an information processing system according to an embodiment of the present invention.

FIG. 2 is an exemplary view showing the result of a control of a debug signal passage permission/inhibition control unit by an override control signal and a debug signal passage control signal in an IO controller mounted on the information processing system.

FIG. 3 is an exemplary view showing that an IO processor of the IO controller mounted on the information processing system is arbitrarily operated by a debug device, by directly inputting the debug signal passage control signal to an input terminal of a loopback unit.

FIG. 4 is an exemplary view showing the configuration of a first modification of the IO controller mounted on the information processing system.

FIG. 5 is an exemplary view showing the configuration of a second modification of the IO controller mounted on the information processing system.

### DETAILED DESCRIPTION

Various embodiments according to the invention will be described hereinafter with reference to the accompanying drawings. In general, according to one embodiment of the invention, an electronic apparatus including a processor including an input terminal to which a debug signal is to be input, a first switch configured to switch between permission and inhibition of passage of the debug signal, a first control unit configured to output a control signal for causing the first switch to perform the switching between the permission and inhibition of passage of the debug signal based on an externally supplied command signal, a second switch configured to convert a control signal outputted from the first control unit for permitting the passage of the debug signal into a. control signal for inhibiting the debug signal, and a second control unit configured to output a control signal for causing the second switch to determine whether or not to perform the conversion based on a command signal from the processor.

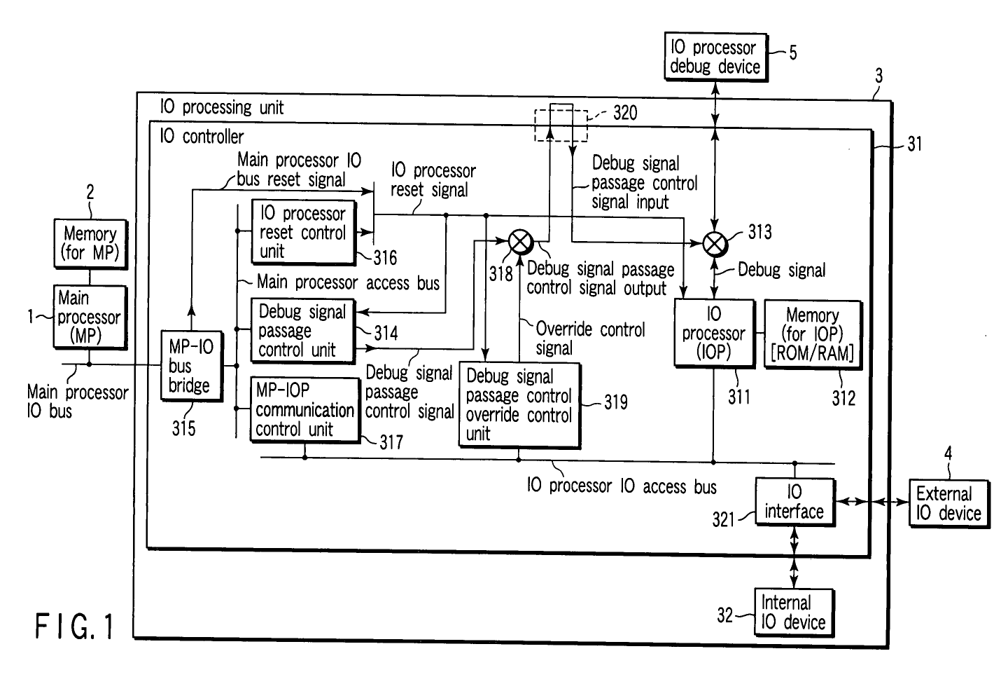

FIG. 1 is an exemplary view showing the configuration of an information processing system according to the embodiment of the present invention. The information processing system corresponds to, e.g., a desktop computer or a notebook computer. In the information processing system, a main processor 1 executes programs stored in a memory 2, thereby performing various functions such as a document composition function, a spreadsheet function, a Web page browsing function and an image reproducing function.

In the information processing system, an IO processing unit 3 is provided which comprises an IO controller 31 (corresponding to an electronic apparatus of the present invention) and an internal IO device 32. The internal IO device 32 is intended to store, e.g., scrambled moving picture data, and the IO controller 31 has a function of performing scrambling processing and descrambling processing. Furthermore, to the IO processing unit 3, an external IO device 4 for storing the scrambled moving picture data is connected. That is, the IO controller 31 performs specific processing, which cannot be known by the outsider, on the data stored in the internal IO device 32 and the external IO device 4.

The IO controller 31 is provided as an integrated circuit, and has a function of receiving a debug signal from the debug device 5 in order that the integrated circuit could be efficiently developed and evaluated. The IO controller 31 has a structure for appropriately performing a control on switching between permission and inhibition of passage of a debug signal from the debug device 5. This will be explained in detail as follows:

The processing of the IO controller 31 can be controlled by an IO processor 311. The IO processor 311 operates based on a program stored in a memory 312. Also, it can operate based on the debug signal from the debug device 5. Furthermore, on a signal line for enabling the debug signal to be transmitted between the IO processor 311 and the debug device 5, a debug signal passage permission/inhibition control unit 313 (first switch) is provided for performing a control on switching between permission and inhibition of passage of the above debug signal.

The debug signal passage permission/inhibition control unit 313 receives a debug signal passage control signal, and determines its operation based on the debug signal passage control signal. As means for controlling supplying of the debug signal passage control signal from an external device, a debug signal passage control unit 314 (first control means) is provided in the IO controller 31.

The debug signal passage control unit 314 is connected to a main processor access bus, and can receive a command signal from the main processor 1 via an MP-IO bus bridge 315 connected to the main processor access bus. The MP-IO bus bridge 315 is a junction circuit which connects a main processor IO bus and the main processor access bus to each other. Based on the command signal from the main processor 1, the debug signal passage control unit 314 outputs a debug signal passage control signal for controlling the debug signal passage permission/inhibition control unit 313.

To the main processor access bus, an IO processor reset control unit 316 and an MP-IOP communication control unit 317 are also connected. The IO processor reset control unit 316 is provided to supply an IO processor reset signal for initializing the IO processor 311, under the control by the main processor 1, and the MP-IOP communication control unit 317 is provided as an interface between the main processor 1 and the IO processor 311.

At the IO controller 31, on a signal line for enabling a debug signal passage signal output from the debug signal passage control unit 314 to be supplied to the debug signal passage permission/inhibition control unit 313, a debug signal passage control permission/inhibition override control unit 318 (second switch) is provided for overriding the debug signal passage control signal.

The debug signal passage control permission/inhibition override control unit 318 is provided to convert that debug signal passage control signal for permitting the passage of the debug signal, which is output from the debug signal passage control unit 314, by into a debug signal passage control signal for inhibiting the passage of the debug signal, and determines whether or not to perform the above conversion after receiving an override control signal. The override control signal is output from a debug signal passage control override control unit 319 (second control means), which is controlled by the IO processor 311.

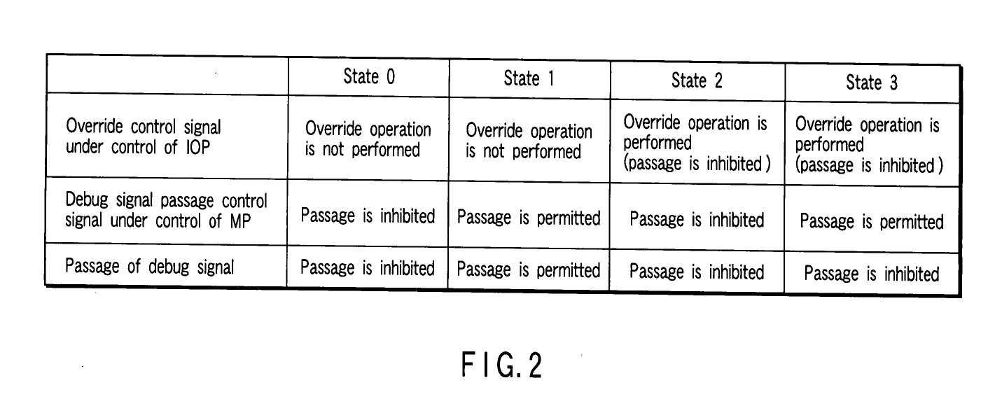

To be more specific, a control performed by the main processor 1 (which is located outside of the IO controller 31) via the debug signal passage control unit 314 is combined with a control performed by the IO processor 311 (which is located in the IC controller 31) via the debug signal passage control override control unit 319. The combination of those controls can bring about four states as shown in FIG. 2. Of these states, only in state 1 in which the debug signal passage control signal for permitting the passage of the debug signal is output under the control of the main processor 1, and the debug signal passage control signal is not overridden, under the control of the IO processor 311, the passage of the debug signal from the debug device 5 is permitted. In other words, even when the debug signal passage control signal for permitting the passage of the debug signal is output under the control of the main processor 1, if the debug signal passage control signal is overridden under the control of the IO processor 311, the control of the main processor 1 is canceled (state 3).

Furthermore, in the IO controller 31, a loopback unit 320 is provided on a signal line which connects the debug signal passage control permission/inhibition override control unit 318 and the debug signal passage permission/inhibition control unit 313. To be more specific, the loopback unit 320 comprises an output terminal from which a signal line extending from the debug signal passage permission/inhibition override control unit 318 is externally extended, i.e., it is extended to the outside of the IO controller 31, and an input terminal from which the externally extended signal line is internally extended, i.e., it is extended to the inside of the IO controller 31. When the loopback unit 320 is provided on a printed board of the IO processing unit 3, it is concealed from the outside. To be more specific, the loopback unit 320 is formed of a wiring pattern on the IO processing unit 3 side, as a result of which it is concealed after being provided on the printed board of the IO processing unit 3.

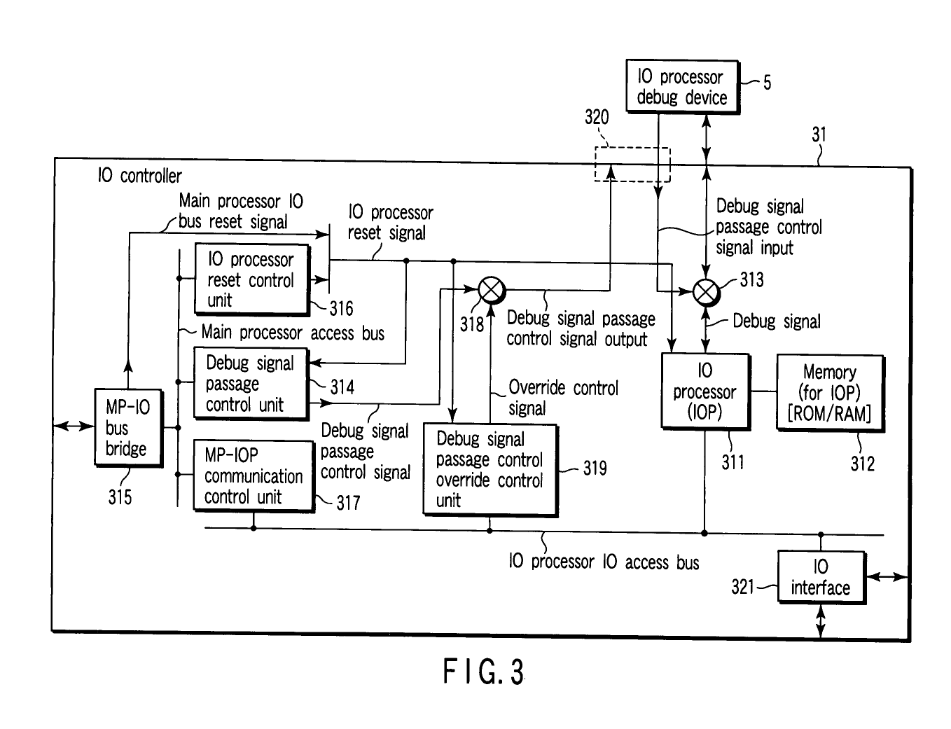

Due to provision of the loopback unit 320, for example, at a relatively early stage of development of the IO controller 3, the IO controller 3 can be handled in such a manner as shown in, e.g., FIG. 3. To be more specific, when the IO controller 31 cannot be provided on the printed board of the IO processing unit 3 in view of its state, or when the IO controller 31 is solely tested in operation, the passage of the debug signal from the debug device 5 is permitted by directly inputting a debug signal passage control signal from the debug device 5 to the input terminal of the loopback unit 320. Thereby, the IO processor 311 can be arbitrarily operated by the debug device 5.

In the above operation, for example, when it can be determined by an evaluation that the program to be executed by the IO processor 311 has no problem, the IO controller 31 is provided on the printed board of the IO processing unit 3, and the test to be carried out proceeds from the above test on the operation of the IO controller 31 to a test on the operation of the system. In the test on the operation of the system, it is set that the above-mentioned overriding operation of the debug signal passage control override unit 319 is not carried out. For example, the above setting is carried out by replacement of a parameter to be referred to in execution of the program which is to be executed by the IO processor 311, and which is used in controlling the debug signal passage control override control unit 319, by another one, or replacement of the above program itself by another one, the replacement being achieved when data in the memory 312 is rewritten. Thus, in order to achieve the replacement, as the memory 312, a memory device such as an EPROM, which can be electrically rewritten in data, is used.

That is, in the case where the debug device 5 is used at the above stage, the debug signal passage control unit 314 is controlled by the main processor 1, thereby permitting the passage of the debug signal from the debug device 5. Thereby, the IO processor 311 can be also arbitrarily controlled by the debug device side.

Furthermore, at the final stage, i.e., when the operation test is completed, and the above information processing system can be shipped as a product, it is set that the override operation of the debug signal passage control override control unit 319 is performed when the memory 312 is rewritten in contents. Thereby, the passage of the debug signal from the debug device 5 is inhibited, as a result of which the processing procedure of the IO controller 31 is reliably prevented from being read by illegally using the debug device 5.

In such a manner, the IO controller 31 can appropriately perform a control on switching between permission and inhibition of the debug signal from the debug signal 5 in accordance with the situation, e.g., in accordance with what processing is carried out in development of the integrated circuit.

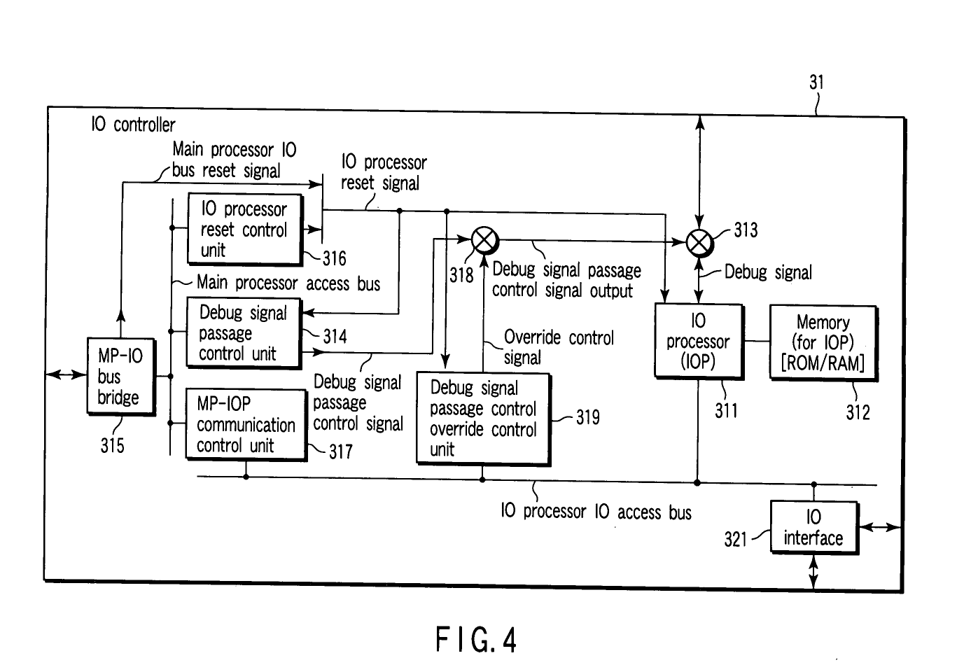

The above explanation is given by referring to the case where the IO controller 31 includes the loopback 320 as shown in FIG. 1. However, even if it does not include the loopback 320, as shown in FIG. 4, advantage can be obtained. This is because the debug signal passage control signal for permitting the passage of the debug signal can be overridden under the control of the IO processor 311 (which is located in the IO controller 31), when the debug signal passage control signal is output under the control of the main processor 1 (which is located outside the IO controller 31).

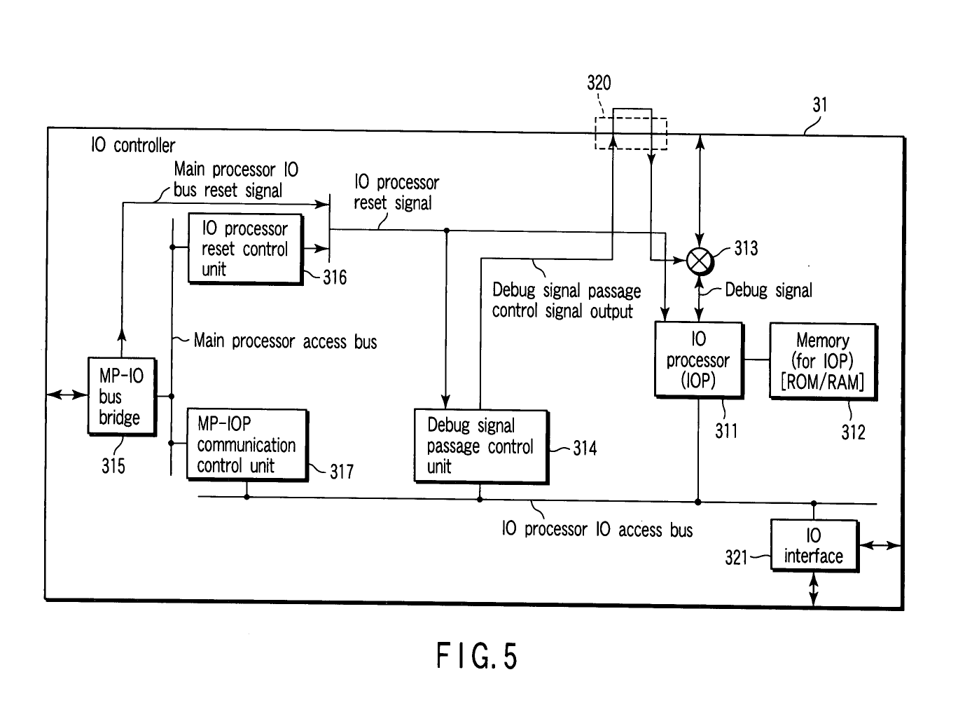

In addition, the following structure may be adopted: in the case where the debug signal passage control unit 314 is controlled by the IO processor 311 located in the IO controller 31 as shown in, e.g., FIG. 5, i.e., it is not controlled by a member located outside the IO controller 31, the above loopback 320 is provided on the signal line which connects the debug signal passage control unit 314 and the debug signal passage permission/inhibition control unit 313.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a processor including an input terminal to which a debug signal is to be input;
a first switch, provided on a signal line for transmitting a debug signal from an external member to the input terminal, configured to switch between permission and inhibition of passage of the debug signal;
a first control unit configured to output a control signal for causing the first switch to perform the switching between the permission and inhibition of passage of the debug signal based on an externally supplied command signal;
a second switch, provided on a signal line for transmitting a control signal from the first control unit to the first switch, configured to convert a control signal outputted from the first control unit for permitting the passage of the debug signal into a control signal for inhibiting the debug signal; and
a second control unit configured to output a control signal for causing the second switch to determine whether or not to perform the conversion based on a command signal from the processor.

2. The electronic apparatus according to claim 1, further comprises a loopback unit including an output terminal from which a signal line for transmitting a control signal from the second switch to the first switch is externally extended, and an input terminal from which the externally extended signal line is internally extended.

3. The electronic apparatus according to claim 2, the apparatus is formed as an integrated circuit, and the loopback unit is provided to be concealed from an outside of the apparatus when the apparatus is located on a printed board.

4. The electronic apparatus according to claim 1, further comprises a memory device which electrically rewritably stores a parameter of a program, which is used in causing the processor to execute an output control of a command signal for the second control unit, and also in causing the processor to output a predetermined command signal to the second control unit.

5. The electronic apparatus according to claim 1, further comprises a memory device which electrically rewritably stores a program for causing the processor to execute an output control of a command signal for the second switch, and also causing the processor to output a predetermined command signal to the second control unit.

6. An electronic apparatus comprising:
a processor including an input terminal to which a debug signal is to be input;
a switch, provided on a signal line for transmitting a debug signal from an external member to the input terminal, configured to switch between permission and inhibition of passage of the debug signal;
a control unit configured to output a control signal for causing the switch to perform the switching between the permission and inhibition of the passage of the debug signal based on a command signal from the processor; and
a loopback unit including an output terminal from which a signal line for transmitting a control signal from the control unit to the switch is externally extended, and an input terminal from which the externally extended signal line is internally extended.

7. The electronic apparatus according to claim 6, the apparatus is formed as an integrated circuit, and the loopback unit is provided to be concealed from an outside of the apparatus when the apparatus is located on a printed board.

8. The electronic apparatus according to claim 6, further comprises a memory device which electrically rewritably stores a parameter of a program, which is used in causing the processor to execute an output control of a command signal for the control unit, and also in causing the processor to output a predetermined command signal to the control unit.

9. The electronic apparatus according to claim 6, further comprises a memory device which electrically rewritably stores a program for causing the processor to execute an output control of a command signal for the switch, and also causing the processor to output a predetermined command signal to the control unit.

10. An electronic apparatus comprises a loopback unit including an output terminal from which a signal line for transmitting a predetermined control signal is externally extended, and an input terminal from which the externally extended signal line is internally extended, the loopback unit is provided to be concealed from an outside of the apparatus when the apparatus is located on a printed board.
